(19) United States
(12) Patent Application Publication
(10) Pub. No.: US 2020/0104009 A1
(43) Pub. Date: Apr. 2, 2020

(54) OPERATING METHOD OF INTERACTIVE TOUCH DISPLAY SYSTEM

(71) Applicant: Aver Information Inc., New Taipei City (TW)

(72) Inventors: Po-Cheng Chen, New Taipei City (TW); Yun-Long Sie, New Taipei City (TW)

(21) Appl. No.: 16/574,160

(22) Filed: Sep. 18, 2019

(30) Foreign Application Priority Data
Sep. 28, 2018 (TW) 107134284

(51) Int. Cl. G06F 3/042; G06F 3/0488

(52) U.S. Cl. CPC G06F 3/0425; G06F 3/04886

(57) ABSTRACT

An operating method of interactive touch display system includes following steps. Step 1 is for executing a scanning process, which is scanning whether at least one object is in a predetermined region in accordance with a camera or not, then calculating to obtain the number of the object if the result is yes (or true). Step 2 is for executing a drawing process in accordance with the number of the object, which is calculating the position of the at least one object to display at least one toolbox corresponding to the at least one object on an interactive display. Wherein the number of the toolbox is equal to the number of the object, and the position of the interactive display of each toolbox corresponds to the position of the predetermined region of each corresponding object.

### CROSS REFERENCE TO RELATED APPLICATIONS

This Non-provisional application claims priority under 35 U.S.C. § 119(a) on Patent Application No. 1071134284 filed in Republic of China on Sep. 28, 2018, the entire contents of which are hereby incorporated by reference.

### BACKGROUND

### 1. Technical Field

The present invention generally relates to a method for operating an interactive touch display system, in particular to an operating method of an interactive touch display system at the same time, which can independently provide the requirements of multiple objects.

### 2. Description of Related Art

With the development of science and technology, the interactive experience is also common in our daily life. Interactive interfaces commonly used in the market, such as the interactive intelligent touch displays (or called as the interactive flat panel or the interactive intelligent panel), are usually cooperated with toolboxes displayed on which display for users to achieve the interesting or educational interactive effects.

An interactive display (such as the electronic whiteboard or drawing board) is usually only for the use of a user with a toolbox; if used by multiple users, it could not be on the same interactive display at the same time, meaning that the interactive display only provides each user to use a toolbox, and each user need to take turns using the toolbox in the interactive display.

If each user wants to use different toolbox and operate on the interactive display at the same time, the interactive display shall match up with the number of users, to firstly divide the interactive display into the independent region with the same number of users. This means that each independent region on the interactive display is independent from interference, and each independent region cannot be connected to each other, and each independent region can only produce a toolbox. Each user has its own independent region and a toolbox on the independent region for operation. Therefore, each user can only use its toolbox in its own or corresponding independent region. In other words, the independent region is as the small independent interactive display respectively, while the interactive display is as multiple independent small interactive displays; however, the independent regions are not connected, but separated and independent with each other; therefore, multiple users are still not in the same interactive display to jointly operate the interactive display.

Therefore, it is an important subject to provide an operating method of an interactive display to improve the above deficiencies and provide users with more interactive experience.

### SUMMARY OF THE INVENTION

In view of the foregoing, the present invention is to provide an operating method of an interactive touch display system, by scanning the object by camera and providing the relative number of toolboxes according to the number of objects, and displaying on the interactive display within the easy operating range of the object, so as to improve the diversity of use of interactive touch display system.

To achieve the above, the present invention is to provide an operating method of an interactive touch display system, including at least the following steps. Step 1 is to execute a scanning process by means of a camera to scan whether there is at least one object within a predetermined region and, if the result is “YES”, to calculate the number of objects. Step 2 is to execute a drawing process of corresponding number of the object, to calculate the position of at least one object within the predetermined region so as to display at least one toolbox in the corresponding interactive display of the interactive touch display system, wherein, the position of at least one toolbox in the interactive display corresponds to the position of its corresponding object within the predetermined region.

In one embodiment of the present invention, the operating method of the interactive touch display system further includes Step 3. Step 3 is to execute an object tracing process, which detects whether the object moves in the predetermined region by camera; if the result is “YES”, calculate the position of each object after moving within the predetermined region to display the toolbox corresponding to the object on the interactive display, and the position of the toolbox shall correspond to the position of the object after moving.

In one embodiment of the present invention, wherein before the execution of the scanning process, a startup process is also included. It detects that when the interactive touch display system receives a drawing execution instruction, a drawing mode is enabled and a camera is turned on.

In one embodiment of the present invention, among the drawing process that execute the corresponding number of objects, the drawing process further includes a first drawing process and a second drawing process. In the scanning process, if the scan result is at least two objects, the number of the object for those objects is calculated, and the first drawing process is executed. And in the first drawing process, calculate the object position within the predetermined region, to display the corresponding toolbox on the interactive display, among which, each toolbox respectively corresponds to each object, and the toolboxes are in the same number of objects, and the position of each toolbox on the interactive display respectively corresponds to the object within the predetermined region.

Continue the aforementioned, when executing the scanning process is to judge whether the number of the object equals to 1; if the result is “YES”, execute the second drawing process; if the result is “NO”, execute the drawing closing process. In the second drawing process, the position of the object within the predetermined region is calculated to obtain an object display position and display the corresponding toolbox on the interactive display. The position of the toolbox on the interactive display corresponds to the position of the object within the predetermined region and has a first preset distance from the display position of the object.

In one embodiment of the present invention, wherein when executing the first drawing process, each toolbox has a preset vertical distance respectively between the position on the interactive display and the side of the interactive display.

In one embodiment of the present invention, wherein when executing the first drawing process, the position of each object within the predetermined region is calculated to obtain an object display position, and there is a first preset distance between the position of the toolbox on the interactive display and the corresponding object display position of the object.

In one embodiment of the present invention, wherein the vertical projection of the predetermined region of the object display position overlaps with the vertical projection of the predetermined region of the object.

In one embodiment of the present invention, wherein the operating method further includes a toolbox reset process, which judges whether the position of each toolbox on the interactive display is the same; if the result is “YES”, make the distance between the position of the toolbox with the same position in the interactive display and object display position of its corresponding object for a second preset distance or a third preset distance, and execute the toolbox reset process; if the result is “NO”, executive the object tracing process.

In one embodiment of the present invention, wherein when executing the object tracing process is to determine if the number of objects equals to the number of toolboxes; if the result is “NO”, calculate the number of objects and the number of toolboxes to obtain a difference, and add or reduce the number of toolboxes according to the difference.

In one embodiment of the present invention, wherein one side edge of the interactive display corresponds to one side of the predetermined region, and the camera is disposed on the side edge of the interactive display.

As mentioned above, on the basis that the present invention is an operating method of the interactive touch display system, through the camera to scan the number of the object and moving condition within the predetermined region, and provide corresponding number of the toolbox according to the number of the object, and display the toolbox position respectively corresponding to their object position on the interactive display. In addition, the toolbox can be displayed within the easy operating range of the object according to the position of the object, and the corresponding toolbox can be moved to the operating range of the object on the interactive display according to the movement of the object. Furthermore, if there are at least two toolboxes overlapping with each other on the interactive display, in the same position or overlapping with each object display position, the toolbox can be moved to other sides of its corresponding object.

Accordingly, it not only can provide multiple objects (users) at the same interactive display and at the same time, and the toolboxes are respectively corresponding to different objects to be used, and can also choose their own needed tool, and synchronously increase or decrease the icon or text drawn by the same or different object on the interactive display through the toolbox; the toolbox is located in the position or on the range that the object can be more easily operated, and the toolbox will not overlap because the multiple objects are too close, thus to promote the use diversification of interactive touch display system, and enhance the user experience.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIG. 1 is a block diagram showing an interactive touch display system according to an embodiment of the present invention.

FIGS. 2A and 2B are flow chart showing an operating method of the interactive touch display system according to the embodiment of the present invention.

### DETAILED DESCRIPTION

Reference will now be made to the drawings to describe various inventive embodiments of the present disclosure in detail, wherein like numerals refer to like elements throughout.

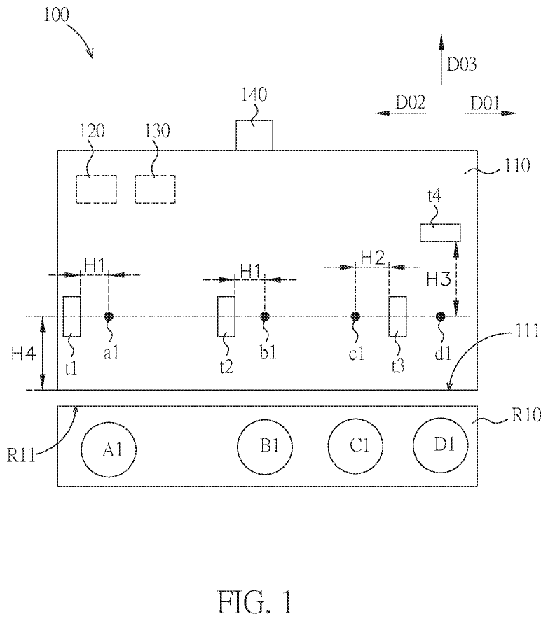

FIG. 1 is a block diagram showing an interactive touch display system according to an embodiment of the present invention. As shown in FIG. 1, an interactive touch display system 100 includes an interactive display 110, a controller 120, a storage module 130 and a camera 140. The controller 120 and the storage module 130 can be disposed inside the interactive display 110 or in a control box (not shown in the figure), while the camera 140 is disposed on the side edge of the interactive display 110.

The operating method of the interactive touch display system 100 has a startup process, a scanning process, a first drawing process, a second drawing process, an object tracing process, a drawing closing process and a toolbox reset process. The interactive touch display system 100 also includes a drawing mode. The interactive touch display system 100 of the embodiment can be applied to advertisement board, video teaching or video course, etc. The interactive display 110 can be a tablet with touch control functions, such as blackboard, whiteboard, electronic whiteboard or writing board and drawing board for teaching. The camera 140 can be the digital camera or video recorder camera. Here, the interactive display 110 is an electronic whiteboard and the camera 140 is a video camera, no restriction thereof.

The startup process, the scanning process, the first drawing process, the second drawing process, the object tracing process, the drawing closing process, and the toolbox reset process may all be stored in the storage module 130, which in the embodiment may be a memory or a storage device, i.e. a hard disk, etc., no restriction thereof.

The camera 140 further includes a lens (not shown in the figure) that has a predetermined region R10. The predetermined region R10 can be the capture range, field of view or angle of view of the lens of the camera 140. The shape of the predetermined region R10 is not limited, but the predetermined region R10 is a rectangle here as the example. Scan by the lens in the predetermined region R10 to see if there is at least two (2) objects, and calculate by the controller 120, to obtain the number of the object and transfer to the controller 120 and/or storage module 130, and trace the object moving direction by the lens in the predetermined region R10, and calculate by the controller 120, to obtain the object moving direction and transfer to the controller 120 and/or storage module 130. The object of the embodiment means the user, so the number of objects is the same as the number of users, that is, one object represents one user.

One side edge of the interactive display 110 corresponds to a side edge of the predetermined region R10. In detail, the length of the side edge of the interactive display 110 corresponds to the side edge of the predetermined region R10 equally or in equal proportion. In addition, the side edge of the interactive display 110 and the side edge of the predetermined region R10 can be parallel to each other. Take the rectangle interactive display 110 as an example. The bottom edge 111 of interactive display 110 corresponds to the long edge R11 of the predetermined region R10, and the bottom edge 111 of the interactive display 110 is parallel and equal to the long edge R11 of the predetermined region R10. In other embodiments, if the bottom edge of the interactive display 110 is greater than or less than the long edge R11 of the predetermined region R10, the proportional relation between the bottom edge of the interactive display 110 and the long edge R11 of the predetermined region R10 can be calculated by the controller, so as to as the position or region of the interactive display 110 and the predetermined region R10 corresponding to each other.

Therefore, when scanning whether there are multiple objects within the predetermined region R10 by the lens of the camera 140, on the basis of the corresponding relation between the side edge of the interactive display 110 and the side edge of the predetermined region R10 by the controller 120, such as in the corresponding and equal long edge relation, calculate the position of the object within the predetermined region R10 to correspond directly and convert to the position of the object on the interactive display 110.

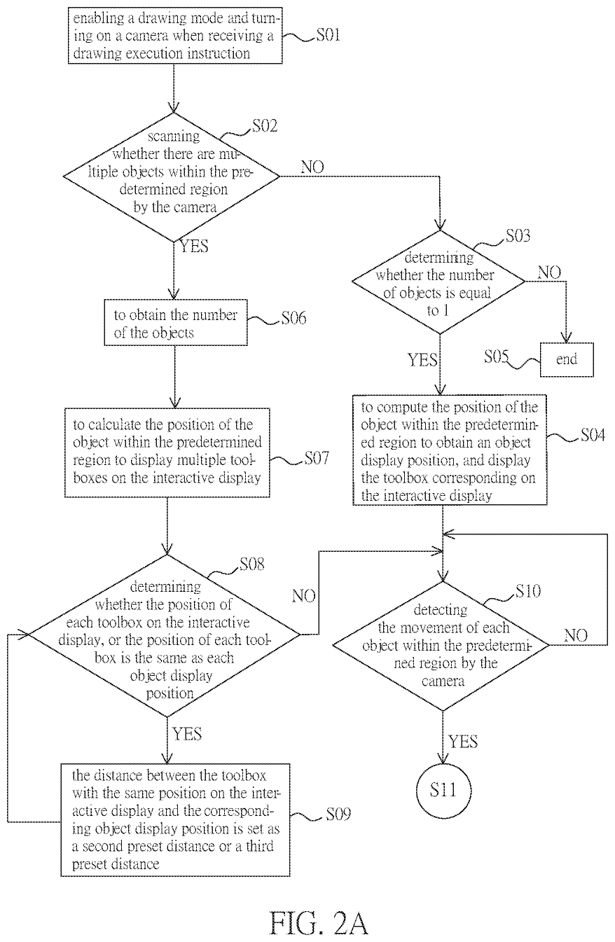

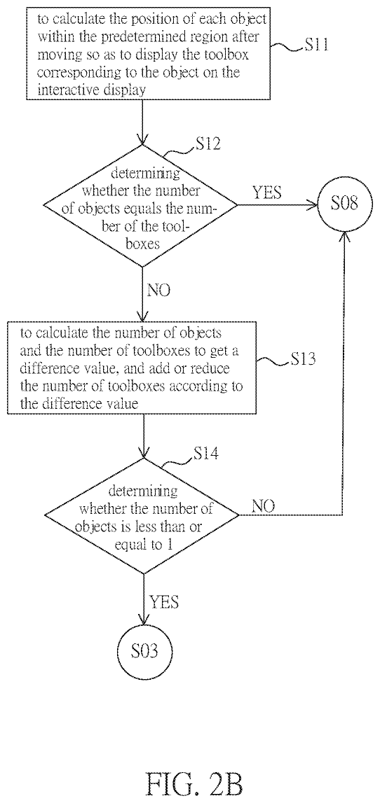

FIGS. 2A and 2B are flow chart showing an operating method of the interactive touch display system according to the embodiment of the present invention. Please refer to FIG. 1, FIG. 2A and FIG. 2B, the following flow chart details the operation of the interactive touch display system 100 and its components. However, the steps in FIGS. 2A and 2B are not limited to the interactive touch display system 100 in FIG. 1, and the interactive touch display system 100 in FIG. 1 is not limited to the steps in FIGS. 2A and 2B.

Step S01 is to execute a startup process, which detects that when receiving a drawing execution instruction, a drawing mode is enabled and the camera 140 is turned on, and then entering Step S02 to execute a scanning process.

In the embodiment, the way of entering the startup process is through the controller 120 to detect whether to receive the drawing execution instructions, and the drawing execution instruction can be a startup signal externally from the interactive touch display system 100; for example, the user manually enters a startup signal, or the interactive touch display system 100 boots and executes the startup process and enters the startup signal to the controller 120. After executing the startup process, the controller 120 directly enters the drawing mode and simultaneously starts the camera 140.

In Step S02, the camera 140 scans whether there are multiple objects within the predetermined region R10. If the result is “YES”, enter Step S06; if the result is “NO”, proceed Step S03. The camera 140 scans the object in the predetermined region R10 (the so-called object here refers to the user) from the top of the interactive display 110, and then captures the image within the predetermined region R10 by the lens of the camera 140, and transmits to the controller 120 to judge or handle relevant information of the object. The method of judging whether it is the object or not by the controller 120 can be determined by hair color, height, clothing of the user or identification mark, no restriction thereof.

Step S03 is to determine whether the number of objects is equal to 1. If the result is “YES”, proceed Step S04 to execute the second drawing process; if the result is “NO”, proceed Step S05 to end. That is, when the controller 120 determines that there is only one user in the lens scanning result of the camera 140, Step S04 will be entered.

Step S04 is to compute the position of object within the predetermined region R10 to obtain an object display position, and display the toolbox corresponding on the interactive display 110. Wherein, the position of the toolbox in the interactive display 110 corresponds to the position of the object within the predetermined region, and there is a first preset distance with the object display position, then Step S10 is entered to execute the object tracing process.

It is further explained that the position of the object A1 within the predetermined region R10 is calculated by controller 120 to obtain the object display position a1, which can be displayed on the interactive display 110 corresponding to the object A; or hide the object display position a1 of the corresponding object A1 on the interactive display 110, which means that the object display position a1 of corresponding object A1 is recorded and stored at the back end but will not be displayed on the interactive display 110.

In addition, the toolbox t1 displayed on interactive display 110 corresponds to both the object A1 and the object display position a1, and there is a first preset distance H1 between the toolbox t1 and the object display position a1. That is to say, there is a first preset distance H1 between the toolbox t1 of the object A1 and its object display position a1 of corresponding object A1 defaulted by the controller 120, and the toolbox t1 can be preset to the left of its corresponding object A and its corresponding object display position a1. That is, when the user representing the object A1 faces the interactive display 110, the toolbox t1 is on the left side of the user. User can use the toolbox t1 to carry out the touch drawing and other operations on interactive display 110. The object display position a1 of the embodiment may be an region on the interactive display 110 where the position of the object A1 within the predetermined region R10 is calculated by the controller 120 to obtain the position of corresponding object A, and this region may be the object display position a1, or the central point of this region may be the object display position a1.

Step S05 is the end. This means that there is no object in the predetermined region R10, namely no user is operating the interactive display 110, which can automatically or manually close the second drawing process, turn off the startup process, or directly turn off the interactive display 110.

Step S06 is to calculate and obtain the number of the objects, then proceed Step S07 to execute a first drawing process. For example, when executing the scanning process through the lens of the camera 140 within the predetermined region R10, and judge the image captured by the lens of the camera 140 within the predetermined region R10 through the controller 120, recognize and get at least two objects; as shown in FIG. 1, the lens of the camera 140 scans along the first direction D1 and cooperate with the controller 120 to calculate and get four objects, in the sequence of object A1, object B1, object C1 and object D1.

Step S07 is to calculate the position of the object within the predetermined region R10 to display multiple toolboxes on the interactive display 110, of which the number of the toolboxes is the same as that of the object. The position of the toolbox on the interactive display 110 corresponds to the position of its corresponding object in the predetermined region, and then enters the toolbox reset process of Step S08.

In the embodiment, the positions of the objects A1, B1, C1 and D1 within the predetermined region R10 are calculated by the controller 120 respectively to display four toolboxes (namely the toolboxes t1, t2, t3 and t4) on interactive display 110. By providing with the toolboxes t1, t2, t3 and t4 of the same number of objects A1, B1, C1 and D1 on the interactive display 110, in addition to the objects A1, B1, C1 and D1 can use its toolboxes t1, t2, t3 and t4 at the same time, it can simultaneously use different functions of the toolboxes t1, t2, t3 and t4 on the interactive display 110 at the same time. For example, the object A1 uses the toolbox t1 for drawing, at the same time, the object B1 uses the toolbox t2 to supplement to the drawing of the object A1, the object C1 uses the toolbox t3 on the other side of the interactive display 110 for text writing, while the object D1 uses the toolbox t4 to modify the content written by the object C1 and supplement the text and graphic attachment for objects A1 and B1 painted icon.

According to the long edge R11 of predetermined region R10 and bottom edge 111 of interactive display 110 paralleling to each other and in the same length, the controller 120 calculates the position of the objects A1, B1, C1 and D1 in the predetermined region R10, and obtains the object display positions a1, b1, c1 and d1 respectively in the interactive display 110, and there is a first preset distance H1 between the position of the toolboxes t1, t2, t3 and t4 in the interactive display 110 and the object display positions a1, b1, c1 and d1 of corresponding objects A1, B1, C1 and D1. Here, the toolboxes t1, t2, t3 and t4 are all preset on the left of the object display positions a1, b1, c1 and d1 of the interactive display 110 from the first preset distance H1. And the vertical projection of the object display positions a1, b1, c1 and d1 in the predetermined region R10 overlaps with the vertical projection of the objects A1, B1, C1 and D1 in the predetermined region R10. Therefore, the object display positions a1, b1, c1 and d1 could correspond to the objects A1, B1, C1 and D1 respectively, on the same line or paralleling to each other.

In addition, the toolboxes t1, t2, t3 and t4 are displayed on one side of the interactive display 110. For example, there is a preset vertical distance H4 between the toolboxes t1, t2, t3 and t4 and the bottom edge 111 of the interactive display 110. That is, the bottom edge 111 of the interactive display 110 is used as the reference line, and each toolbox is displayed on the interactive display 110 according to the preset vertical distance H4. Namely, on the interactive display 110, the toolboxes t1, t2, t3 and t4 are displayed in sequence along the first direction D1, and each of the toolboxes t1, t2, t3 and t4 is separated from the bottom edge 111 of the interactive display 110 by the preset vertical distance H4.

The object display positions a1, b1, c1 and d1 of the embodiment can be four regions through the controller 120 calculating the position of the objects A1, B1, C1 and D1 within the predetermined region R10 to obtain the position of corresponding objects A1, B1, C1 and D1 on the interactive display 110 respectively, and the four regions can be respectively are the object display positions a1, b1, c1 and d1, or the center of the four regions are respectively the object display positions a1, b1, c1 and d1, no restriction thereof.

The position of each object A, B, C and D of the embodiment in the predetermined region R10 can be a position value, a position region or a coordinate value, and the position of each toolbox t1, t2, t3 and t4 and each object display position a1, b1, c1 and d1 can also respectively be a position value, a position region or a coordinate value, no restriction thereof.

Step S08 is to determine whether the position of each toolbox on the interactive display 110 or the position of each toolbox is the same as each object display position. If the result is “YES”, enter Step S09; if the result is “NO”, proceed Step S10 to execute the object tracing process.

In Step S09, the distance between the toolbox with the same position on the interactive display 110 and the corresponding object display position is set as a second preset distance or a third preset distance.

In the embodiment, when the position of each object A1, B1, C1 and D1 corresponding to each toolbox t1, t2, t3 and t4 has been set, namely the distance between each toolbox t1, t2, t3 and t4 and the object display position a1, b1, c1 and d1 respectively is the first preset distance, and is displayed on the interactive display 110, and then the controller 120 shall judge whether the position of each toolbox t1, t2, t3, t4 displayed in the interactive display 110 are the same or judge whether the distance between the position of each toolbox t1, t2, t3 and t4 and each object display position a1, b1, c1 and d1 are the same. It means to judge whether there is any overlap between the toolboxes t1, t2, t3 and t4, or whether the toolboxes t1, t2, t3 and t4 fall into or overlap within the range of the object display position a1, b1, c1 and d1. If there is any overlap, it will cause the inconvenience of object A1, B1, C1 and D1, namely the users, in using the toolbox t1, t2, t3 and t4, or even the unusable situation. For example, the position of the objects B1 and C1 in the predetermined region R10 essentially is very close; as a result, when the controller 120 sets the distance between each toolbox t2 and t3 and the object display position b1 and c1 of the object B1 and C1 for the first preset distance H1 (namely, each toolbox t2 and t3 is respectively on the interactive display 110 and relatively on the left of the object B1 and C1), the controller 120 judges whether the toolbox t3 overlaps with the object display position b1, or falls within the scope of the object display position b1. Therefore, the distance between the toolbox t3 corresponding to the object C1 and the object display position c1 is then set to the second preset distance H2.

At this point, the controller 120 judges again whether the positions of all toolboxes t1, t2, t3 and t4 displayed on the interactive display 110 are the same, or whether the positions of all toolboxes t1, t2, t3 and t4 are the same as each object display position a1, b1, c1 and d1. Therefore, since the positions between object C1 and D1 are substantially close in the predetermined region R10, the controller 120 judges corresponding toolbox t3 may have the same position as the toolbox t4. Accordingly, the distance between the toolbox t4 corresponding to the object D1 and the object display position d1 will be set as the third preset distance H3.

The first preset distance H1, the second preset distance H2 and the third preset distance H3 of the embodiment can be easily operated within the scope of object A1, B1, C1 and D1, while the first preset distance H1, the second preset distance H2 and the third preset distance H3 can be the same or different. In addition, the toolbox can be defined to be located in different directions of the object display position of corresponding object by means of the first preset distance H1, the second preset distance H2 and the third preset distance H3. For example, when the toolbox t3 is located in a first direction D01 of the object display position c1 of its corresponding object C1, there is the second preset distance H2 between them. When the toolboxes t1 and t2 are located in a second direction D02 of the object display positions a1 and b1, there is the first preset distance H1 between them. When the toolbox t4 is located in a third direction D03 of the object display position d1 of corresponding object D1, there is the third preset distance H3 between them.

Step S10 is to detect the movement of each object within the predetermined region by means of the camera. If the result is “YES”, enter Step S11; if the result is “NO”, repeat Step S10.

Step S11 is to calculate the position of each object within the predetermined region after moving so as to display the toolbox corresponding to the object on the interactive display 110, and the position of the toolbox corresponds to the position of the object after moving. In the embodiment, the camera 140 is used to detect the movement of each object A1, B1, C1 and D1 within the predetermined region R10, which means to detect the movement of each object A1, B1, C1 and D1. When each object A1, B1, C1 and D1 are not moved, the object tracing process shall be executed again. In addition, when each object A1, B1, C1 and D1 are not moved, the object tracing process can be executed again at a preset time interval.

When one of the objects A1, B1, C1 and D1 moves, the controller 120 shall calculate the object after moving, such as the position of object D1 (object D1 after moving is not shown in the figure) after moving within the predetermined region R10, to display corresponding toolbox t4 of the object D1 after moving on the interactive display 110, and the position of the toolbox t4 corresponds to the object D after moving and its object display position d1.

Step S12 is to determine whether the number of objects equals the number of the toolboxes. If the result is “NO”, proceed Step S13; if the result is “YES”, enter Step S08.

Step S13 is to calculate the number of objects and the number of toolboxes to obtain a difference value, and add or reduce the number of toolboxes according to the difference value. For example, when the object D1 leaves the predetermined region R10 (not shown in the figure), the controller 120 judges that there are three objects at present, that is, the number of objects A1, B1 and C1 is not equal to the number of toolboxes t1, t2, t3 and t4 which is four. Taking the number of objects minus the number of toolboxes as the difference, the value is “−1”. At this point, the controller 120 will close one toolbox (that is, toolbox t4).

If the controller 120 judges that there are five objects at present, that is, the number of object A1, B1, C1, D1 and another object (not shown in the figure) is not equal to the number of toolboxes t1, t2, t3 and t4. Taking the number of objects minus the number of toolboxes as the difference, the value is “1”. At this point, the controller 120 will add one toolbox (not shown in the figure), to make the number of toolboxes to five.

Step S14 is to determine whether the number of objects is less than or equal to 1. If the result is “YES”, enter Step S03; if the result is “NO”, proceed Step S08.

As mentioned above, the camera 140 of the interactive touch display system 100 scans the number of object A1, B1, C1 and D1 and moving condition in the predetermined region, to provide the same number of toolbox t1, t2, t3 and t4 according to the number of object A1, B1, C1 and D1, and correspond the toolbox t1, t2, t3 and t4 respectively to the position of object A1, B1, C1 and D1 to display corresponding on the interactive display 110. In addition, the toolboxes t1, t2, t3, and t4 can be displayed within the scope that object A1, B1, C1 and D1 can be easily operated in accordance with the position of object A1, B1, C1 and D1, and also according to the moving of object A1, B1, C1 and D1, corresponding toolbox t1, t2, t3 and t4 of the object A1, B1, C1 and D1 on the interactive display 110 shall be moved to the scope that the object of A1, B1, C1 and D1 can be easily operated. Furthermore, if the toolbox t1, t2, t3, t4 overlaps on the interactive display 110, in the same position, or overlaps with the object display position a1, b1, c1 and d1, the toolbox t1, t2, t3 and t4 can be moved to the other side of its corresponding object A1, B1, C1 and D1, which means that the distance between the toolbox t1, t2, t3 and t4 and the object display position a1, b1, c1 and d1 of its corresponding object A1, B1, C1 and D1 are the first preset distance H1, the second preset distance H2 or the third preset distance H3.

Therefore, the same interactive display 110 could not only be operated by different users (such as the object A1, B1, C1 and D1) at the same time, and each user has a corresponding toolbox t1, t2, t3 and t4, and can choose their own needed tools, and also can use the toolbox t1, t2, t3 and t4 to process the graphic or text drawn by users on the interactive display 110 at the same time. In addition, the toolbox t1, t2, t3 and t4 can be located in a range or position that can be easily operated by the user according to the user's position. Moreover, the toolbox t1, t2, t3 and t4 will not overlap with each other due to the close proximity of multiple users. Therefore, it can increase the diversity of the use of interactive display 110, and further enhance the user experience, so as to facilitate the application in more application fields.

What is claimed is:

1. An operating method of an interactive touch display system, comprising:
executing a scanning process by means of a camera to scan whether there is at least one object within a predetermined region and, if the result is “YES”, to calculate the number of objects; and
executing a drawing process of corresponding number of the object, to calculate the position of at least one object within the predetermined region so as to display at least one toolbox in the interactive display of the interactive touch display system, wherein, the position of at least one toolbox in the interactive display corresponds to the position of its corresponding object within the predetermined region.

2. The operating method of claim 1, wherein before the execution of the scanning process, further comprises a startup process, which detects that when the interactive touch display system receives a drawing execution instruction, a drawing mode is enabled and the camera is turned on.

3. The operating method of claim 1, wherein the drawing process further comprises a first drawing process and a second drawing process during the drawing processs that execute the corresponding number of the objects.

4. The operating method of claim 3, further comprising:
in the scanning process, if the scan result is at least two objects, the number of the object for those objects is calculated, and the first drawing process is executed; and
in the first drawing process, is to calculate the object positions within the predetermined region, to display the corresponding toolboxes on the interactive display, among which, each toolbox respectively corresponds to each object, and the toolboxes are in the same number of the objects, and the position of each toolbox on the interactive display respectively corresponds to the object within the predetermined region.

5. The operating method of claim 3, further comprising:
in the scanning process, is to judge whether the number of the object equals to 1, and to execute the second drawing process if the result is “YES”; and
in the second drawing process, is to calculate the position of the object within the predetermined region to obtain an object display position and display the corresponding toolbox on the interactive display, and the position of the toolbox on the interactive display corresponds to the position of the object within the predetermined region and has a first preset distance from the object display position.

6. The operating method of claim 3, wherein when executing the first drawing process, each toolbox has a preset vertical distance respectively between the position on the interactive display and a side edge of the interactive display.

7. The operating method of claim 3, wherein when executing the first drawing process, the position of each object within the predetermined region is calculated to obtain an object display position, and there is a first preset distance between the position of the toolbox on the interactive display and the corresponding object display position of the object.

8. The operating method of claim 7, wherein the vertical projection of the predetermined region of the object display position overlaps with the vertical projection of the predetermined region of the object.

9. The operating method of claim 7, further comprises a toolbox reset process, which is to judge whether the position of each toolbox on the interactive display is the same, and to make the distance between the position of the toolbox with the same position on the interactive display and the object display position of its corresponding object for a second preset distance or a third preset distance, and repeat the toolbox reset process if the result is “YES”, otherwise to execute an object tracing process if the result is “NO”.

10. The operating method of claim 1, further comprising:
executing an object tracing process, which detects whether the objects move in the predetermined region by the camera, if the result is “YES”, calculate the position of each object after moving within the predetermined region to display the toolbox corresponding to the object on the interactive display, and the position of the toolbox corresponds to the position of the object after moving.

11. The operating method of claim 10, wherein the object tracing process, further comprising:
determining whether the number of objects equals to the number of the toolboxes, and if the result is “NO”, calculate the number of the objects and the number of the toolboxes to obtain a difference, and add or reduce the number of toolboxes according to the difference.

12. The operating method of claim 1, wherein one side edge of the interactive display corresponds to one side edge of the predetermined region, and the camera is disposed on the side edge of the interactive display.
